(19) United States
(12) Patent Application Publication
(10) Pub. No.: US 2022/0201061 A1
(43) Pub. Date: Jun. 23, 2022

(54) OFFLOAD OF MEDIA FRAME BROADCASTING TO A NETWORK INTERFACE DEVICE

(71) Applicant: Intel Corporation, Santa Clara, CA (US)

(72) Inventors: Rafal SZTEJNA, Gdansk (PL); Vipin VARGHESE, Thrissur (IN)

(21) Appl. No.: 17/689,675

(22) Filed: Mar. 8, 2022

(51) Int. Cl. H04L 65/65; H04L 65/60; H04L 65/80

(52) U.S. Cl. CPC H04L 65/608; H04L 65/80; H04L 65/601

(57) ABSTRACT

Examples described herein relate to a packet processing device that includes circuitry to form one or more packets with raw media data for transmission to a sender based on a Real-time Transport Protocol (RTP). In some examples, the circuitry is to form one or more packets with raw pixel media in a manner consistent with Society of Motion Picture and Television Engineers (SMPTE) 2110 (2018). In some examples, the raw media data comprises one or more of: raw video and/or raw audio data.

### BACKGROUND

Society of Motion Picture and Television Engineers (SMPTE) 2110 (2018) is a suite of standards that specifies a manner of sending digital video, audio, and related information through a network to a receiver. SMPTE 2110 specifies a manner of Real-time Transport Protocol (RTP) to transmit streaming video and audio.

### BRIEF DESCRIPTION OF THE DRAWINGS

FIG. 1 depicts an example system.

FIG. 2 depicts an example system that can be used to generate and transmit video.

FIG. 3 depicts an example of video frame buffer splitting.

FIG. 4 depicts an example operation of packet construction.

FIG. 5 depicts an example of data movement from host to offload.

FIG. 6 depicts an example of video frame metadata.

FIG. 7 depicts an example operation.

FIG. 8 depicts an example system.

FIG. 9 depicts an example operation.

FIG. 10 depicts an example operation.

FIG. 11A depicts an example process.

FIG. 11B depicts an example process.

FIG. 12 depicts an example packet processing device.

FIG. 13 depicts an example computing system.

FIG. 14 depicts an example system.

### DETAILED DESCRIPTION

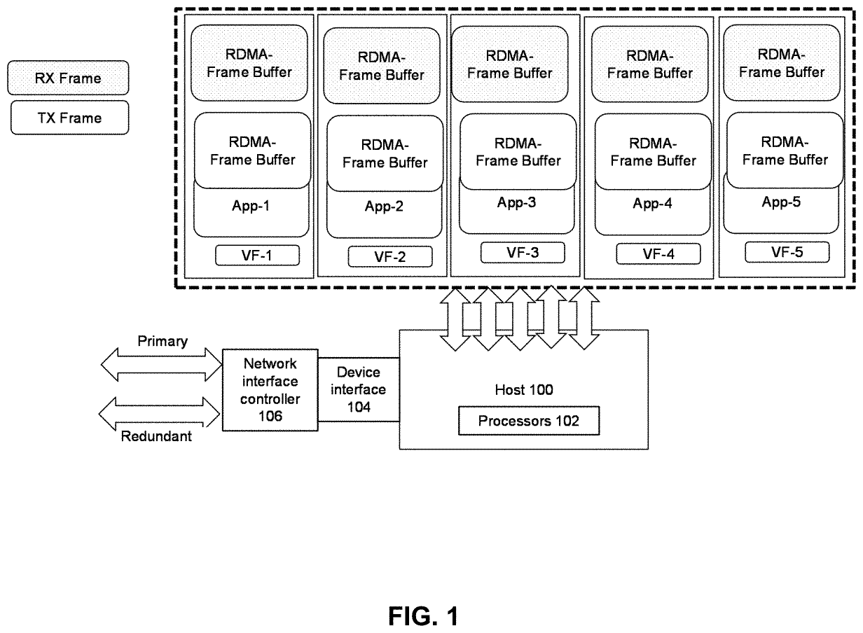

FIG. 1 depicts an example system. Host 100 can generate media data (e.g., video, audio, and supplemental information) using processors 102. Network interface controller 106 can transmit media data to provide video streaming and broadcasting service and/or receive media data that is part of a video streaming and broadcasting service. Device interface 104 can provide communications between host 100 and network interface controller 106. For example, processors 102 can form packets to transmit video frame buffers in accordance with a Real-time Transport Protocol (RTP) based on Ethernet, Internet Protocol (IP), and/or User Datagram Protocol (UDP). For received media, processors 102 can process a stream of network packets to reconstruct a transmitted video frame.

Video traffic can be sent using an RTP protocol (e.g., SMPTE ST2110) lossless with no encoding or compression, where packets that include media data belonging to a same video frame share a same timestamp. Additionally, when two paths are used for redundancy (e.g., primary and redundant streams), packets with same pixel data (e.g., video and audio data) can be transmitted and received.

In some cases, processors 102 and device interface 104 resources (e.g., Peripheral Component Interconnect express (PCIe) lanes) can be used for transmission of portions of video frame buffers in one or more packets. Similarly, as the receiver, processors 102 and device interface 104 resources can be used to reconstruct a video frame buffer received in one or more packets. As the reliability of network path is not assured, a video buffer can be transmitted over primary and redundant paths using multi-protocol label switching (MPLS), 802.1Q tunneling (Q-in-Q), or Virtual Extensible LAN (VxLAN).

Utilization of processors 102 and device interface 104 resources for network transport processing and video buffer processing can increase to process video and packets transmitted and/or received over redundant paths. Resources of processors 102 and device interface 104 can be utilized for frame buffer reconstruction including evicting redundant packets from primary and redundant ports and copying the reconstructed frame buffer per session to application memory space.

To at least partially reduce a load on host processors and device interface lanes, the network and packet processing of transmitted and received media data can be offloaded to a network interface device with programmable processors and circuitry. For example, video frame transmission, the network interface device can perform at least packet infrastructure origination (e.g., Internet Protocol (IP), virtual local area network (VLAN), VxLAN, IP security (IPSEC)), video frame segmentation, and coalescing the processed video data can be offloaded to the network interface device. As a receiver, the network interface device can perform at least packet infrastructure termination (e.g., Internet Protocol (IP), VLAN, VxLAN, IPSEC) and video buffer reconstruction. The network interface device can copy to host memory one or more of: reconstructed video and meta-data such as one or more of: video frame buffer timestamp, histogram indicating transmitted lines, source Internet Protocol (IP) address, destination IP address, source User Datagram Protocol (UDP) port, destination UDP port, or user specific data.

Programmability of processors and circuitry of network interface device can allow for re-configuration to support changes in media streaming standards or support of new media streaming standards.

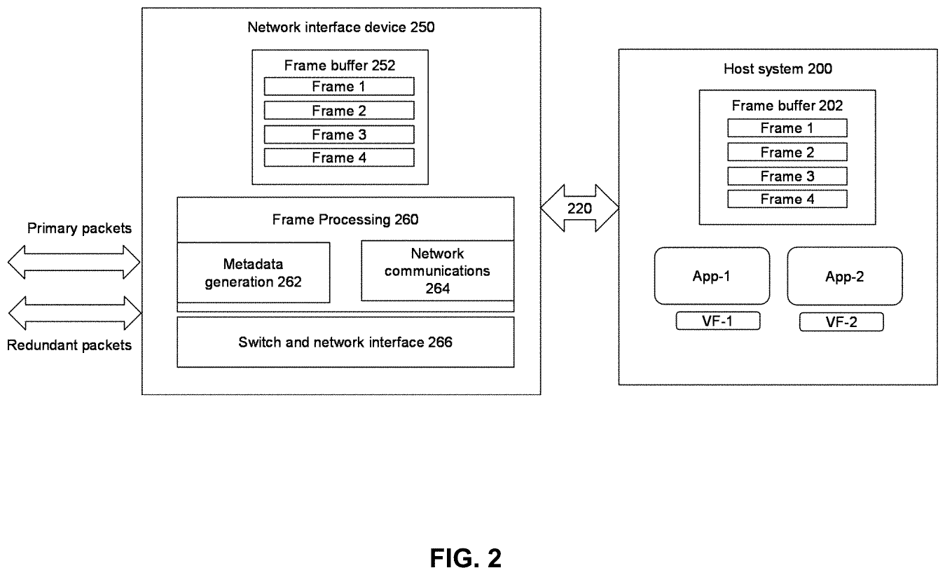

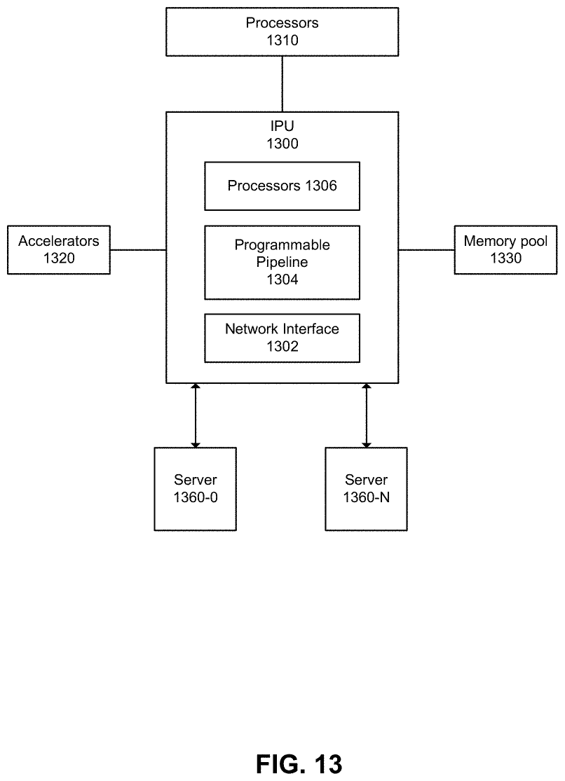

FIG. 2 depicts an example system that can be used to generate and transmit video. Host system 200 can include processors that can execute one or more applications (e.g., App-1 and App-2). Applications can also include one or more of: a virtual machine (VM), application, container, microservice, thread, process, and/or function. Various examples of host 200 and network interface device 250 include elements described at least with respect to FIGS. 13 and/or 14. Processors (not shown) of host system 200 can execute applications that generate media data include raw or uncompressed video frames, associated audio and associated data (e.g., close caption information or other data prescribed by a relevant video streaming standard such as SMPTE 2110). For example, raw or uncompressed video frames, associated audio and associated data can include image, video, and/or audio data prior to image processing or compression, wherein compression attempts to reduce a number of bits that represent image, video, and/or audio data or reduces a number of bits that represent image, video, and/or audio data.

Applications can generate a complete frame or multiple video lines with meta-data specifying one or more of: full buffer, frame buffer split to lower resolution, timestamp (e.g., generated by host 200 or network interface device 250), and histogram (e.g., bitmap of video line positions in the generated frame or video lines). In some examples, applications can generate video as part of a content delivery network (CDN). A CDN can include geographically distributed servers that deliver content, including video to destination devices.

Device interface 220 can provide communications between host 200 and network interface device 250. For example, device interface 220 can operate in a manner consistent with a Joint Electronic Device Engineering Council (JEDEC) Double Data Rate (DDR) standard, Compute Express Link (CXL) (e.g., Compute Express Link Specification revision 2.0, version 0.9 (2020), as well as earlier versions, revisions or variations thereof), Peripheral Component Interconnect express (PCIe) (e.g., PCI Express Base Specification 1.0 (2002), as well as earlier versions, revisions or variations thereof), or other interfaces.

Network interface device 250 can include one or more of: a network interface controller (NIC), a remote direct memory access (RDMA)-enabled NIC, SmartNIC, router, switch, forwarding element, infrastructure processing unit (IPU), or data processing unit (DPU). Network interface device 250 can include one or more of: programmable processors, microprocessors, cores, programmable packet processing circuitry, field programmable gate array (FPGA), application specific integrated circuit (ASIC), one or more memory devices, and/or other circuitry. Frame processing 260 including metadata generation 262 and/or network communications 264 can be implemented by programming of programmable processors, microprocessors, cores, programmable packet processing circuitry, FPGA, and/or ASIC.

Frame processing 260 can access buffered video frame data, packetize video into packets, and apply time stamps and other metadata. Frame processing 260 can copy one or more frames (e.g., frames 1-4) from frame buffer 202 to frame buffer 252. Frame processing 260 can utilize direct memory access (DMA) circuitry to copy one or more frames from frame buffer 202 to frame buffer 252. Frames in frame buffer 252 can represent media data (e.g., video, audio, and/or associated data). Frame buffer 252 can be a region in a memory device of network interface device 250 in which applications executed by host system 200 and a frame processing 260 to share raw video buffers to be sent or that were received. Note that reference to video frames can refer to audio frames as well.

Metadata generation 262 can generate packet metadata for one or more frames in frame buffer 252. Packet metadata can include one or more of: video frame buffer timestamp, histogram indicating transmitted lines, source Internet Protocol (IP) address, destination IP address, source User Datagram Protocol (UDP) port identifier, or other data. Various example of metadata are specified in SMPTE 2110 and various RTP RFCs. At least for SMPTE 2110, packets can be transmitted as packets with IP, UDP, and RTP identifiers and an application associated with such IP address and receiving packets associated with such UDP port can terminate or process video packets.

Network communications 264 can segment a video frame and associated packet metadata to be transmitted in one or more packets, including one or more jumbo frames. Network communications 264 can generate primary and redundant packets to transmit a video frame, or portion thereof, to a receiver. Network communications 264 can duplicate a video line payload for transmission in packets in primary and redundant paths and include infrastructure headers such as VLAN, MPLS, IPSEC, and/or VxLan.

Network communications 264 can utilize Real-time Transport Protocol (RTP) for transmission of packets that include a media stream. An example of RTP is described in RFC 3550 (2003) and variations and derivatives thereof. RTP carries the media streams (e.g., audio and video). Video payload formats include, but are not limited to, H.261, H.263, H.264, H.265, MPEG-1, MPEG-2, and/or MPEG-4. Packet formats to map MPEG-4 audio/video into RTP packets are specified, for example, in RFC 3016 (2000). Supported audio payload formats include, but are not limited to, G.711, G.723, G.726, G.729, GSM, QCELP, MP3, and DTMF. For example, network communications 264 can utilize media streaming services such as Dynamic Streaming over HTTP (DASH) protocol or HTTP Live Streaming (HLS).

Network communications 264 can form packets with IP and UDP headers and that include RTP packages. In connection with packet transmission to a destination, network communications 264 can perform Multiprotocol Label Switching (MPLS) routing, VxLan encapsulation protocol, Load Balancing, Equal-cost multipath (ECMP), or other operations. For example, UDP datagrams can be transmitted over IP protocol with a unique IP address and dedicated UDP port per stream type (e.g., video, audio, or ancillary).

Network communications 264 can prepare primary and redundant packet payloads for transmission in packets with Ethernet, IP, UDP, and RTP header fields. Network communications 264 can schedule packets for transmission from both primary and redundant ports. Network communications 264 can schedule packets for transmission in a proper order based on increasing time slots.

Switch and network interface 266 can provide communications within network interface device and between network interface device and another network interface device. Network interface can include communications circuitry such as one or more of: a network interface controller (NIC), host fabric interface (HFI), and other examples described herein.

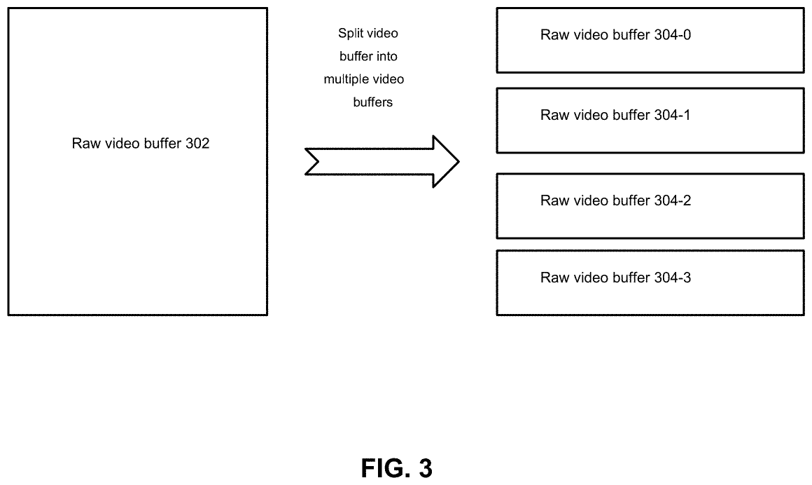

FIG. 3 depicts an example of video frame buffer splitting. A network interface device can divide a frame into multiple parts and associate the parts with different buffers. When a number of pixels in buffer is higher in single stream, meeting packet gapping and time resolution specifications of SMPTE 2110 can be challenging because of a volume of packets used to transmit the video frame buffer. By splitting a frame into smaller frames, multiple streams can be transmitted. SMPTE 2110 specifies a larger time resolution and gaps for multiple streams, such that time resolution and gaps may be more readily achieved by a network interface device. Dividing raw video frame buffer 302 into multiple video buffers 304-0 to 30-3 can assist with achieving time stamp precision and inter-packet gaps because SMPTE 2110 specifies a larger time resolution and gaps for transmissions from multiple buffers. Multiple buffers can include video of lower or same resolution as source buffer 302. Although four video buffers are shown, fewer or more than four video buffers can be used.

In some examples, frame processing 260 can perform the video frame buffer splitting of contents of video frame buffer 302 into video buffers 304-0 to 304-3. In some cases, video data in video buffers 304-0 to 304-3 can be lower resolution than that of source video frame 302.

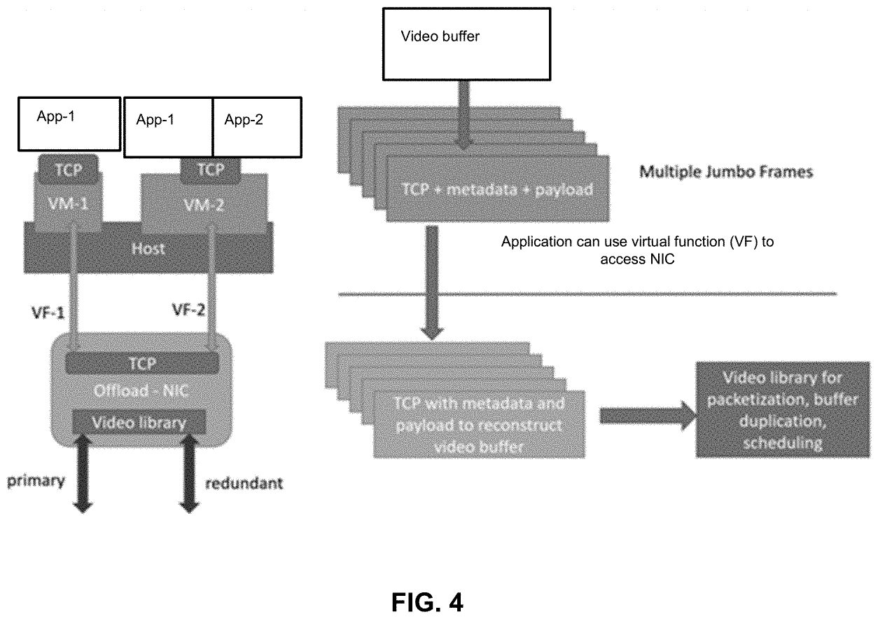

FIG. 4 depicts an example operation of packet construction. Applications (App-1 and App-2) can use virtual function (VF) (e.g., VF-1 and VF-2) to access NIC with circuitry to perform a video library to perform offloaded streaming of lossless media data. NIC can transmit primary and redundant packets to a receiver.

Metadata associated with a payload in a video buffer can include information such as timestamp, whether the buffer send is for full or partial frame (e.g., histogram), video lines present, whether frame has been split to lower resolution. Based on the video buffer received from a host, NIC can construct a header with Ethernet, IP, UDP, and RTP fields with video line data per port for primary and redundant paths. NIC can add infrastructure headers (e.g., IPSEC, MPLS, or VxLAN) and schedule the packets for transmission over primary and redundant paths. NIC can send completion event with metadata details back to host to indicate completion of video frame transmission.

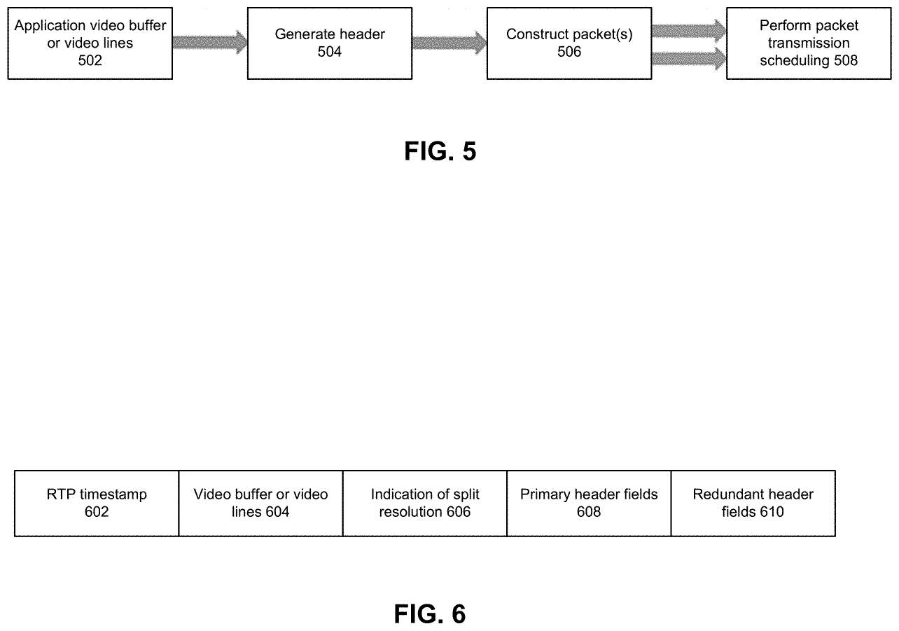

FIG. 5 depicts an example of data movement from host to offload. Host application can utilize an application program interface (API) to communicate with a network interface device with programmable circuitry to set up an audio-video session and register callbacks, actions (e.g., request next buffer, video frame complete call back to indicate next buffer is ready). At 502, host application can create video frames with one or more video lines and specify a time stamp (e.g., number of seconds after epoch time). Time stamps can grow in value throughout a video. At 504, network interface device with programmable circuitry can generate one or more headers for video buffer or video lines. At 506, network interface device with programmable circuitry can construct one or more packets that include a video frame buffer or one or more lines of a video and headers. At 508, the network interface device with programmable circuitry can schedule packets for transmission to a receiver with packet spacing defined in SMPTE 2110.

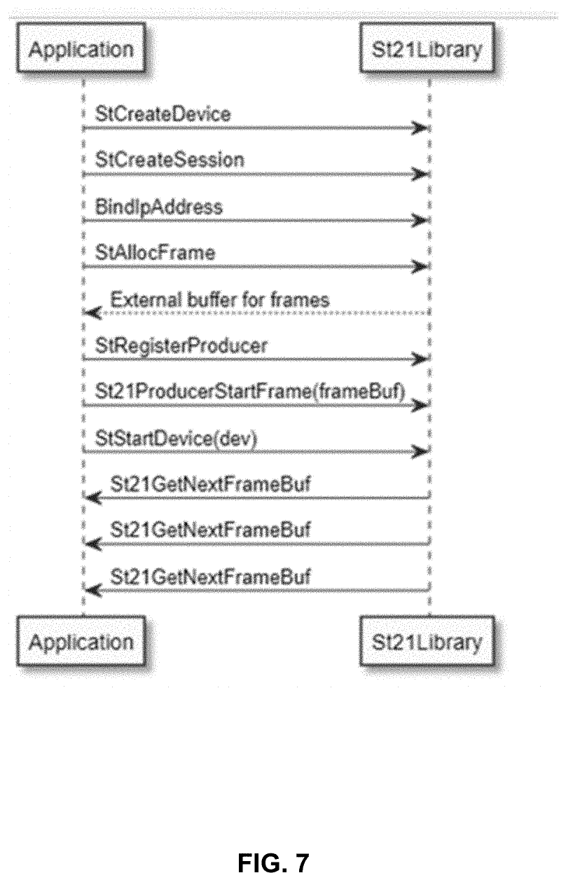

FIG. 6 depicts an example of video frame metadata. Metadata can include RTP timestamp 602, histogram indicating lines of video frame conveyed 604, indication of whether video buffer is split to lower resolution partial frames 606, primary header fields 608 (e.g., Source IP address, destination IP address, UDP ports and user specific data), and redundant header fields 610 (e.g., Source IP address, destination IP address, source UDP port, destination UDP port, and/or user specific data).

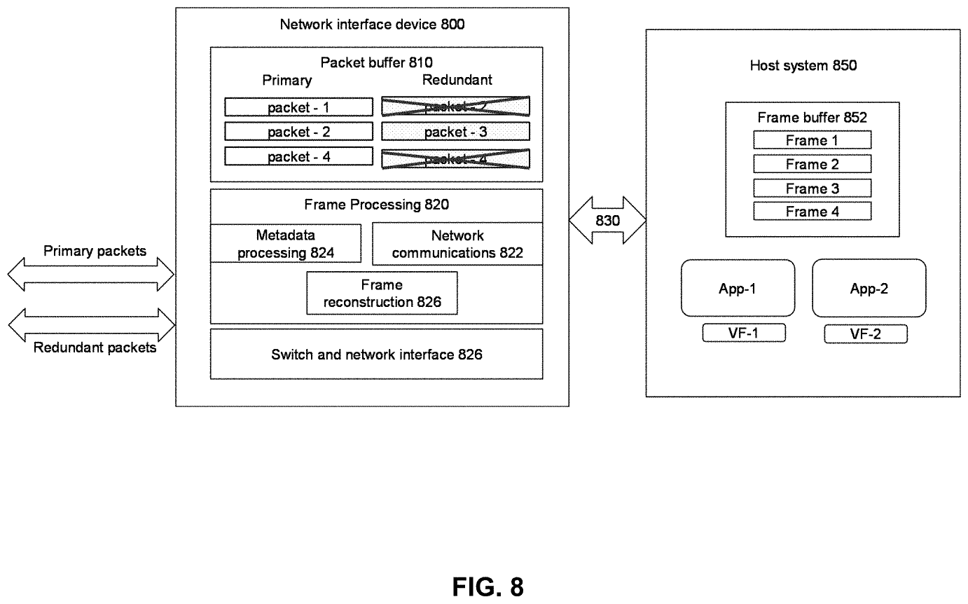

FIG. 7 depicts an example operation of software executing on a host and a network interface device (e.g., packet processing device). Application can be executed by a host and can generate one or more media data for transmission to a receiver. St21 Library can represent a process executed by a network interface device that can perform offloaded video streaming operations. StCreateDevicecan be called by the application to initialize frame processing on the network interface device. StCreateSession can be called by the application to create a video session on network interface device. BindIPAdress can be called by both transmitter and receiver to assign IP addresses of the stream. StAllocFrame can be called by the application to allocate memory for transmitting frames. StRegisterProducer can be called by the application to register a producer for video streaming. St21ProducerStartFrame can be called by the application to start a frame of video streaming and can indicate a first frame buffer for the session, offset in complete lines of the frame buffer after which a producer filled the buffer, timestamp of the frame, start new frame at a timestamp and offset. StStartDevice can be called by the application to start a ST2110 streaming session. St21GetNextFrameBuf can call a producer or consumer application to get the next frame buffer to continue streaming. A pointer to a buffer containing a video frame to be transmitted or a buffer that will be used to receive a next frame can be made available.

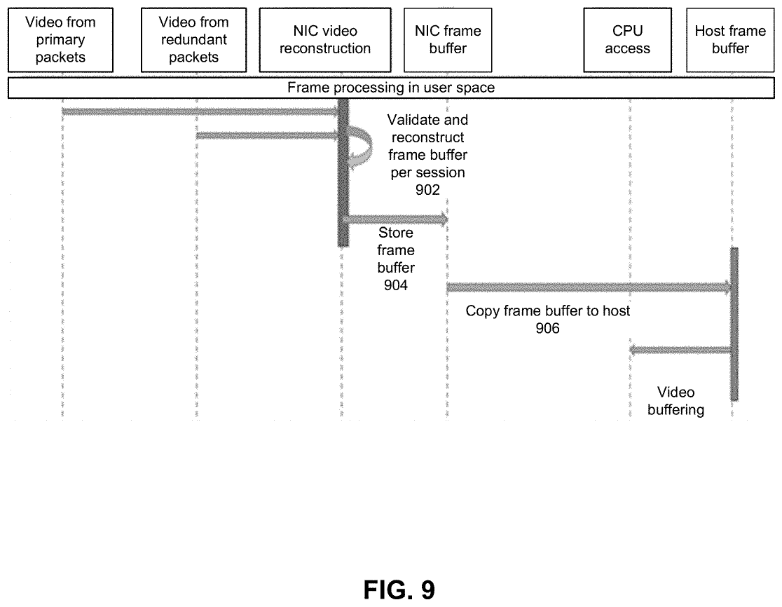

FIG. 8 depicts an example system to process received video using a network interface device. Host system 850 can offload video frame reconstruction to network interface device 800. Host system 850 can include processors that can execute one or more applications (e.g., App-1 and App-2). Applications can also include one or more of: a virtual machine (VM), application, container, microservice, thread, process, and/or function. Various examples of host 850 and network interface device 250 include elements described at least with respect to FIGS. 13 and/or 14. Processors (not shown) of host system 850 can execute applications that access uncompressed video frames, associated audio and associated data (e.g., close caption information or other data prescribed by a relevant video streaming standard such as SMPTE 2110).

Device interface 830 can provide communications between network interface device 800 and host 850. For example, device interface 830 can operate in a manner consistent with a DDR standard, CXL, PCIe, or other interfaces.

Network interface device 800 can include one or more of: a network interface controller (NIC), a remote direct memory access (RDMA)-enabled NIC, SmartNIC, router, switch, forwarding element, infrastructure processing unit (IPU), or data processing unit (DPU). Network interface device 800 can include one or more of: programmable processors, microprocessors, cores, programmable packet processing circuitry, field programmable gate array (FPGA), application specific integrated circuit (ASIC), one or more memory devices, and/or other circuitry. Frame processing 820 including network communications 822, metadata processing 822, and frame reconstruction 826 can be implemented by programming of programmable processors, microprocessors, cores, programmable packet processing circuitry, FPGA, and/or ASIC.

Network communications 822 can terminate MPLS, VxLAN, and IPSEC connections of received primary and redundant packets. Network communications 822 can identify and bifurcate the primary and redundant packets based on one or more of the following header fields in received packets: Source IP address, destination IP address, source UDP port, and/or destination UDP port. Network communications 822 can select one or more received video frames (or a portion of a video frame) from primary and redundant packets. Content of a redundant packet can be used to retrieve a portion of a video frame where a primary packet was not received by network interface device. In this example, a video frame is reconstructed from primary packets 1, 2, and 4 and redundant packet 3.

Metadata processing 824 can process metadata in received packets. Packet metadata can include one or more of: video frame time stamp, histogram data, identifiers of video and audio, ancillary information, and primary or redundant packets (e.g., sent to different receiver IP addresses but video frames have same time stamp). Metadata processing 824 can analyze histogram data that identifies currently assembled in current frame such that when same pixel data is received from both primary and redundant paths, data can be dropped based on availability of specific pixels in an already processed output video buffer.

Frame reconstruction 826 can reconstruct a video buffer from primary and/or redundant packet payloads. Frame reconstruction 826 can analyze RTP timestamps in incoming packets and reconstruct a full video frame based on packets containing a same timestamp. If a new time stamp is received in a packet before a full video frame associated with a prior time stamp is completed, then the currently processed frame can be stored in backup and video frame data of the new time stamp frame can be processed. If a threshold number of packets received or time passes and complete frame has not been received, an incomplete video frame can be sent to host frame buffer 852. Frame reconstruction 826 can forward a video frame with metadata to a frame buffer accessible in host system.

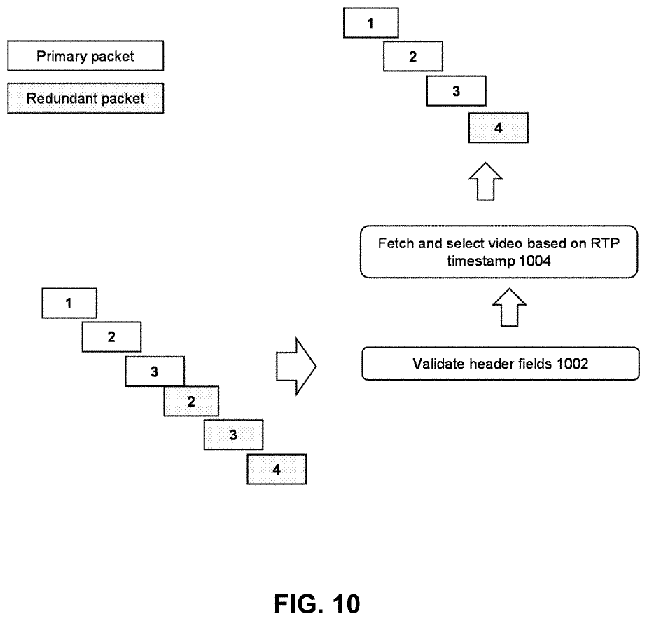

FIG. 9 depicts an example operation of media streamer library at a network interface device that receives packets with video frame buffers. At 902, network interface device can validate and reconstruct a video frame buffer from payloads of one or more primary and redundant packets. Validation of a video frame buffer can include validating that counters and number of packets are as expected for a given video resolution. At 904, network interface device can store a reconstructed frame buffer. At 906, network interface device can copy a reconstructed video frame buffer to host frame buffer for access by host.

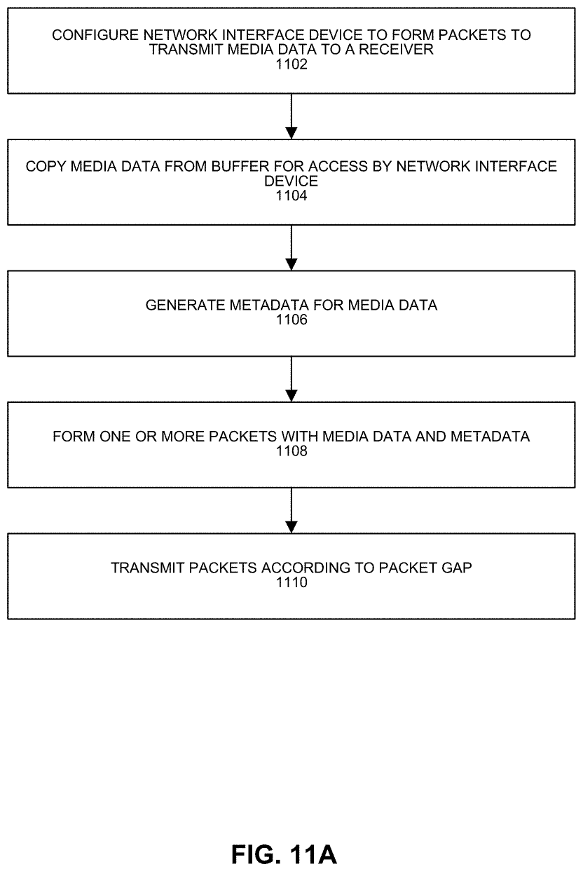

FIG. 10 depicts an example operation of a network interface device that receives one or more packets that include video frames, or portions thereof (e.g., lines of a video frame buffer). The receiver network interface device can reconstruct a video frame buffer from one or more primary and redundant packet payloads. At 1002, after validating IP, UDP, and RTP header fields, a video frame buffer from a primary or redundant packet can be selected based on time stamp values. At 1004, a received primary or redundant packet that includes a higher time stamp value can be selected for utilization in video frame buffer reconstruction. In this example, primary packets carry video frame buffers for video frame buffers 1-3. A time stamp for video frame buffer 4 is higher or subsequent to a time stamp for video frame buffer 3. However, a primary packet carrying video frame buffer 4 and associated time stamp was not received before redundant packet carrying a video frame buffer for video frame buffer 4. Should a packet be received with a time stamp that is prior to time stamp for video frame buffer 3, such packet can be dropped.

The following is an example pseudocode of video frame buffer reconstruction based on received time stamps from primary and redundant packets.

```
int reconstructVideoBuffer (struct rte_mbuf *m)
{
    /* get the pointer to ipv4, rtp */
    /* save the current time stamp from RTP header */
/* Validate the IP & UDP header */
    /* Validate the RTP header */
    /* check if the timestamp expected and received timestamp are same
    *
    * Is yes: account the buffer and copy to the buffer to video frame
    buffer
    * Is no: check if it for a new frame, then flush the previous buffer
start storing the as new/current buffer
    */
}
```

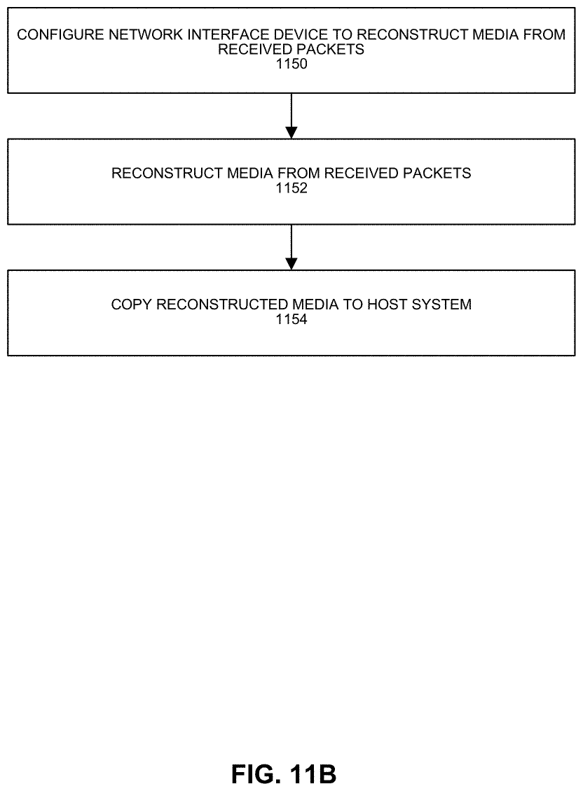

FIG. 11A depicts an example process. The process can be performed by circuitry of a network interface device. At 1102, a network interface device can be configured to transmit packets with uncompressed media data and metadata. In some examples, the media data can include video, audio, and or ancillary data. In some examples, the media data is to be transmitted in accordance with SMPTE 2110. At 1104, the network interface device can copy media data from a buffer in a host. The media data can be generated by a media streaming application executing on the host. At 1106, the network interface device can generate metadata for the media data. The metadata can include one or more of: video frame buffer timestamp, histogram indicating transmitted lines, source Internet Protocol (IP) address, destination IP address, User Datagram Protocol (UDP) ports, or user specific data. At 1108, the network interface device can form one or more packets with the media data and associated metadata. At 1110, the network interface device can transmit packets in accordance with a packet spacing or gap set by an applicable streaming video standard. Primary and redundant packets can be transmitted.

FIG. 11B depicts an example process. The process can be performed by circuitry of a network interface device. At 1150, a network interface device can be configured to reconstruct uncompressed media data from received packets. The received packets can include primary and redundant packets. At 1152, the network interface device can reconstruct a media frame buffer (e.g., video frame buffer and audio frame buffer) based on metadata in received packets. Pixels associated with a same time stamp can be formed together to reconstruct a video frame buffer. At 1154, the network interface device can copy a reconstructed media frame buffer to memory accessible to a host. The media data can be accessed by a media streaming application executing on the host.

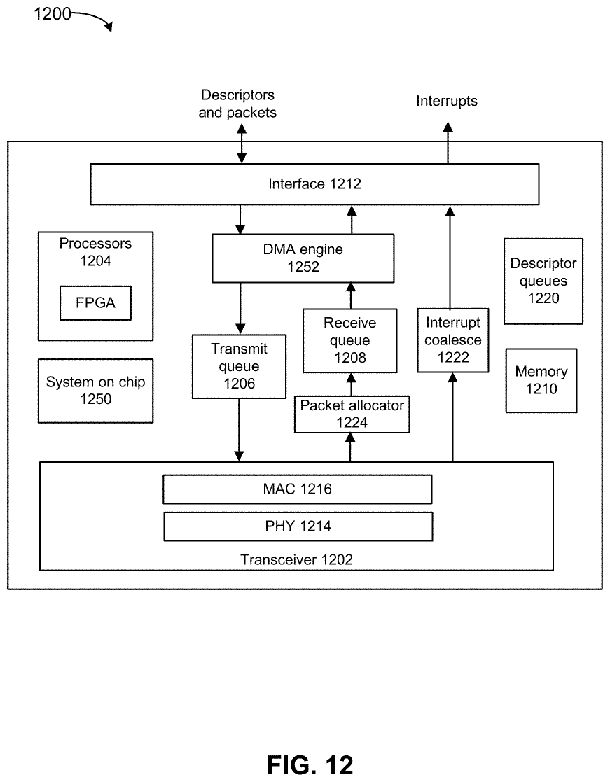

FIG. 12 depicts an example packet processing device. The network interface device can be configured to transmit video frame data in one or more packets and/or generate video frame data from one or more received packets, as described herein. Network interface 1200 can include transceiver 1202, processors 1204, transmit queue 1206, receive queue 1208, memory 1210, and bus interface 1212, and DMA engine 1252. Transceiver 1202 can be capable of receiving and transmitting packets in conformance with the applicable protocols such as Ethernet as described in IEEE 802.3, although other protocols may be used. Transceiver 1202 can receive and transmit packets from and to a network via a network medium (not depicted). Transceiver 1202 can include PHY circuitry 1214 and media access control (MAC) circuitry 1216. PHY circuitry 1214 can include encoding and decoding circuitry (not shown) to encode and decode data packets according to applicable physical layer specifications or standards. MAC circuitry 1216 can be configured to assemble data to be transmitted into packets, that include destination and source addresses along with network control information and error detection hash values.

Processors 1204 can be any a combination of a: processor, core, graphics processing unit (GPU), field programmable gate array (FPGA), application specific integrated circuit (ASIC), or other programmable hardware device that allow programming of network interface 1200. For example, a “smart network interface” can provide packet processing capabilities in the network interface using processors 1204. Processors 1204 can include a packet processing pipeline. A packet processing pipeline can determine which port to transfer packets or frames to using a table that maps packet characteristics with an associated output port. A packet processing pipeline can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. A packet processing pipeline can implement access control list (ACL) or packet drops due to queue overflow.

Configuration of operation of processors 1204, including its data plane, can be programmed using Programming Protocol-independent Packet Processors (P4), C, Python, Broadcom Network Programming Language (NPL), NVIDIA® CUDA®, NVIDIA® DOCATM or x86 compatible executable binaries or other executable binaries. Processors 1204 and/or system on chip 1250 can be configured to transmit video frame data in one or more packets and/or generate video frame data from one or more received packets, as described herein.

Packet allocator 1224 can provide distribution of received packets for processing by multiple CPUs or cores using timeslot allocation described herein or RSS. When packet allocator 1224 uses RSS, packet allocator 1224 can calculate a hash or make another determination based on contents of a received packet to determine which CPU or core is to process a packet.

Interrupt coalesce 1222 can perform interrupt moderation whereby network interface interrupt coalesce 1222 waits for multiple packets to arrive, or for a time-out to expire, before generating an interrupt to host system to process received packet(s). Receive Segment Coalescing (RSC) can be performed by network interface 1200 whereby portions of incoming packets are combined into segments of a packet. Network interface 1200 provides this coalesced packet to an application.

Direct memory access (DMA) engine 1252 can copy a packet header, packet payload, and/or descriptor directly from host memory to the network interface or vice versa, instead of copying the packet to an intermediate buffer at the host and then using another copy operation from the intermediate buffer to the destination buffer.

Memory 1210 can be any type of volatile or non-volatile memory device and can store any queue or instructions used to program network interface 1200. Transmit queue 1206 can include data or references to data for transmission by network interface. Receive queue 1208 can include data or references to data that was received by network interface from a network. Descriptor queues 1220 can include descriptors that reference data or packets in transmit queue 1206 or receive queue 1208. Bus interface 1212 can provide an interface with host device (not depicted). For example, bus interface 1212 can be compatible with PCI, PCI Express, PCI-x, Serial ATA, and/or USB compatible interface (although other interconnection standards may be used).

FIG. 13 depicts an example system. In this system, IPU 1300 manages performance of one or more processes using one or more of processors 1306, processors 1310, accelerators 1320, memory pool 1330, or servers 1340-0 to 1340-N, where N is an integer of 1 or more. In some examples, processors 1306 of IPU 1300 can execute one or more processes, applications, VMs, containers, microservices, and so forth that request performance of workloads by one or more of: processors 1310, accelerators 1320, memory pool 1330, and/or servers 1340-0 to 1340-N. IPU 1300 can utilize network interface 1302 or one or more device interfaces to communicate with processors 1310, accelerators 1320, memory pool 1330, and/or servers 1340-0 to 1340-N. IPU 1300 can utilize programmable pipeline 1304 to process packets that are to be transmitted from network interface 1302 or packets received from network interface 1302. Programmable pipeline 1304 and/or processors 1306 can be configured to transmit video frame data in one or more packets and/or generate video frame data from one or more received packets, as described herein.

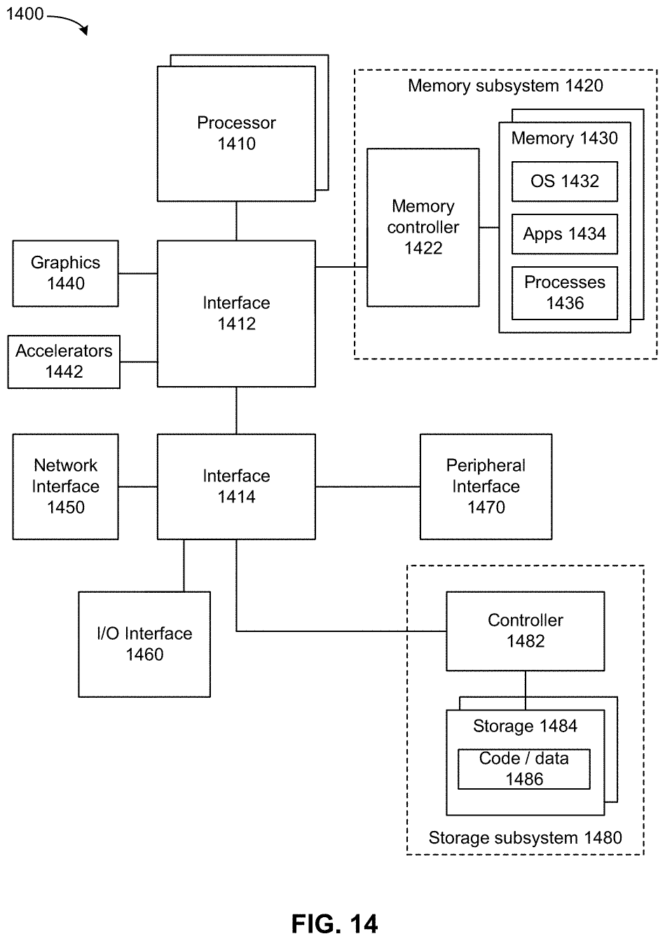

FIG. 14 depicts a system. Components of system 1400 (e.g., network interface 1450) can be configured to transmit video frame data in one or more packets and/or generate video frame data from one or more received packets, as described herein. System 1400 includes processor 1410, which provides processing, operation management, and execution of instructions for system 1400. Processor 1410 can include any type of microprocessor, central processing unit (CPU), graphics processing unit (GPU), XPU, processing core, or other processing hardware to provide processing for system 1400, or a combination of processors. An XPU can include one or more of: a CPU, a graphics processing unit (GPU), general purpose GPU (GPGPU), and/or other processing units (e.g., accelerators or programmable or fixed function FPGAs). Processor 1410 controls the overall operation of system 1400, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1400 includes interface 1412 coupled to processor 1410, which can represent a higher speed interface or a high throughput interface for system components that needs higher bandwidth connections, such as memory subsystem 1420 or graphics interface components 1440, or accelerators 1442. Interface 1412 represents an interface circuit, which can be a standalone component or integrated onto a processor die. Where present, graphics interface 1440 interfaces to graphics components for providing a visual display to a user of system 1400. In one example, graphics interface 1440 can drive a display that provides an output to a user. In one example, the display can include a touchscreen display. In one example, graphics interface 1440 generates a display based on data stored in memory 1430 or based on operations executed by processor 1410 or both. In one example, graphics interface 1440 generates a display based on data stored in memory 1430 or based on operations executed by processor 1410 or both.

Accelerators 1442 can be a programmable or fixed function offload engine that can be accessed or used by a processor 1410. For example, an accelerator among accelerators 1442 can provide data compression (DC) capability, cryptography services such as public key encryption (PKE), cipher, hash/authentication capabilities, decryption, or other capabilities or services. In some embodiments, in addition or alternatively, an accelerator among accelerators 1442 provides field select controller capabilities as described herein. In some cases, accelerators 1442 can be integrated into a CPU socket (e.g., a connector to a motherboard or circuit board that includes a CPU and provides an electrical interface with the CPU). For example, accelerators 1442 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1442 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 1420 represents the main memory of system 1400 and provides storage for code to be executed by processor 1410, or data values to be used in executing a routine. Memory subsystem 1420 can include one or more memory devices 1430 such as read-only memory (ROM), flash memory, one or more varieties of random access memory (RAM) such as DRAM, or other memory devices, or a combination of such devices. Memory 1430 stores and hosts, among other things, operating system (OS) 1432 to provide a software platform for execution of instructions in system 1400. Additionally, applications 1434 can execute on the software platform of OS 1432 from memory 1430. Applications 1434 represent programs that have their own operational logic to perform execution of one or more functions. Processes 1436 represent agents or routines that provide auxiliary functions to OS 1432 or one or more applications 1434 or a combination. OS 1432, applications 1434, and processes 1436 provide software logic to provide functions for system 1400. In one example, memory subsystem 1420 includes memory controller 1422, which is a memory controller to generate and issue commands to memory 1430. It will be understood that memory controller 1422 could be a physical part of processor 1410 or a physical part of interface 1412. For example, memory controller 1422 can be an integrated memory controller, integrated onto a circuit with processor 1410.

Applications 1434 and/or processes 1436 can request network interface device 1450 to transmit video frame data in one or more packets and/or generate video frame data from one or more received packets, as described herein.

Applications 1434 and/or processes 1436 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

A virtualized execution environment (VEE) can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

In some examples, OS 1432 can be Linux®, Windows® Server or personal computer, FreeBSD®, Android®, MacOS®, iOS®, VMware vSphere, openSUSE, RHEL, CentOS, Debian, Ubuntu, or any other operating system. OS 1432 and driver can execute on a processor sold or designed by Intel®, ARM®, AMD®, Qualcomm®, IBM®, Nvidia®, Broadcom®, Texas Instruments®, among others. OS 1432 and/or driver can configure network interface device 1450 to transmit video frame data in one or more packets and/or generate video frame data from one or more received packets, as described herein. In some examples, network interface device 1450 or its driver can advertise or indicate to OS 1432 capability of network interface device 1450 to form one or more packets with raw media data in primary and redundant streams for transmission to a sender based on a Real-time Transport Protocol (RTP) and/or generate video frame data from one or more received packets in primary and redundant streams, as described herein.

While not specifically illustrated, it will be understood that system 1400 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1400 includes interface 1414, which can be coupled to interface 1412. In one example, interface 1414 represents an interface circuit, which can include standalone components and integrated circuitry. In one example, multiple user interface components or peripheral components, or both, couple to interface 1414. Network interface 1450 provides system 1400 the ability to communicate with remote devices (e.g., servers or other computing devices) over one or more networks. Network interface 1450 can include an Ethernet adapter, wireless interconnection components, cellular network interconnection components, USB (universal serial bus), or other wired or wireless standards-based or proprietary interfaces. Network interface 1450 can transmit data to a device that is in the same data center or rack or a remote device, which can include sending data stored in memory. Network interface 1450 (e.g., packet processing device) can execute a virtual switch to provide virtual machine-to-virtual machine communications for virtual machines (or other VEEs) in a same server or among different servers. Network interface 1450 can receive data from a remote device, which can include storing received data into memory. In some examples, network interface 1450 can refer to one or more of: a network interface controller (NIC), a remote direct memory access (RDMA)-enabled NIC, SmartNIC, router, switch, forwarding element, infrastructure processing unit (IPU), or data processing unit (DPU).

As described herein, network interface 1450 can be configured to transmit video frame data in one or more packets and/or generate video frame data from one or more received packets, as described herein.

In one example, system 1400 includes one or more input/output (I/O) interface(s) 1460. I/O interface 1460 can include one or more interface components through which a user interacts with system 1400 (e.g., audio, alphanumeric, tactile/touch, or other interfacing). Peripheral interface 1470 can include any hardware interface not specifically mentioned above. Peripherals refer generally to devices that connect dependently to system 1400. A dependent connection is one where system 1400 provides the software platform or hardware platform or both on which operation executes, and with which a user interacts.

In one example, system 1400 includes storage subsystem 1480 to store data in a nonvolatile manner. In one example, in certain system implementations, at least certain components of storage 1480 can overlap with components of memory subsystem 1420. Storage subsystem 1480 includes storage device(s) 1484, which can be or include any conventional medium for storing large amounts of data in a nonvolatile manner, such as one or more magnetic, solid state, or optical based disks, or a combination. Storage 1484 holds code or instructions and data 1486 in a persistent state (e.g., the value is retained despite interruption of power to system 1400). Storage 1484 can be generically considered to be a “memory,” although memory 1430 is typically the executing or operating memory to provide instructions to processor 1410. Whereas storage 1484 is nonvolatile, memory 1430 can include volatile memory (e.g., the value or state of the data is indeterminate if power is interrupted to system 1400). In one example, storage subsystem 1480 includes controller 1482 to interface with storage 1484. In one example controller 1482 is a physical part of interface 1414 or processor 1410 or can include circuits or logic in both processor 1410 and interface 1414.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM).

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, or NVM devices that use chalcogenide phase change material (for example, chalcogenide glass).

A power source (not depicted) provides power to the components of system 1400. More specifically, power source typically interfaces to one or multiple power supplies in system 1400 to provide power to the components of system 1400. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 1400 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

In an example, system 1400 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for another. For example, descriptions using the terms “connected” and/or “coupled” may indicate that two or more elements are in direct physical or electrical contact with another. The term “coupled,” however, may also mean that two or more elements are not in direct contact with another, but yet still co-operate or interact with another.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. A component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

Example 1 can include one or more examples and an apparatus comprising: a packet processing device comprising: circuitry to form one or more packets with raw media data for transmission to a sender based on a Real-time Transport Protocol (RTP).

Example 2 can include one or more examples, wherein the circuitry is to form one or more packets with raw pixel media in a manner consistent with Society of Motion Picture and Television Engineers (SMPTE) 2110 (2018).

Example 3 can include one or more examples, wherein the raw media data comprises one or more of: raw video and/or raw audio data.

Example 4 can include one or more examples, wherein to form one or more packets with raw media data for transmission to a sender, the circuitry is to form one or more primary and redundant packets, wherein the primary and redundant packets include the raw media data.

Example 5 can include one or more examples, wherein to form one or more packets with raw media data for transmission to a sender, the circuitry is to include metadata in the one or more packets, wherein the metadata comprises one or more of: timestamp, histogram of video line positions of the raw media data, source Internet Protocol (IP) address, destination IP address, source User Datagram Protocol (UDP) port, or destination UDP port.

Example 6 can include one or more examples, wherein packets belonging to a same video frame share a same timestamp.

Example 7 can include one or more examples, wherein to form one or more packets with raw media data for transmission to a sender, the circuitry is to manage multi-protocol label switching (MPLS), virtual local area network (VLAN), or Virtual Extensible LAN (Vana).

Example 8 can include one or more examples and includes a host system communicatively coupled to the packet processing device, wherein the host system is to generate the raw media data.

Example 9 can include one or more examples, wherein the packet processing device comprises one or more of: a network interface controller (MC), a remote direct memory access (RDMA)-enabled NIC, SmartNIC, router, switch, forwarding element, infrastructure processing unit (IPU), or data processing unit (DPU).

Example 10 can include one or more examples and includes an apparatus comprising: a packet processing device comprising: circuitry to access one or more received packets received via a Real-time Transport Protocol (RTP) and reconstruct frames of raw media data from content of the one or more received packets.

Example 11 can include one or more examples, wherein the packet processing device comprises circuitry to terminate network communications can terminate IP Security (IPSEC), multi-protocol label switching (MPLS), or Virtual Extensible LAN (VxLAN) of received primary and redundant packets.

Example 12 can include one or more examples, wherein the packet processing device comprises circuitry to identify and bifurcate received primary and redundant packets and select one or more received video frames from the primary and redundant packets.

Example 13 can include one or more examples, wherein the packet processing device comprises circuitry to copy a video frame of the raw media data to a frame buffer in a host system.

Example 14 can include one or more examples, wherein the one or more received packets are consistent with Society of Motion Picture and Television Engineers (SMPTE) 2110 (2018).

Example 15 can include one or more examples, wherein the raw media data comprises one or more of: raw video and/or raw audio data.

Example 16 can include one or more examples and includes a non-transitory computer-readable medium comprising instructions stored thereon, that if executed by one or more processors, cause the one or more processors to: offload to a packet processing device: formation one or more packets with raw media data for transmission to a sender based on a Real-time Transport Protocol (RTP).

Example 17 can include one or more examples, wherein the packet processing device is to form one or more packets with raw pixel media in a manner consistent with Society of Motion Picture and Television Engineers (SMPTE) 2110 (2018).

Example 18 can include one or more examples, wherein the raw media data comprises one or more of: raw video and/or raw audio data.

Example 19 can include one or more examples, wherein the formation of one or more packets with raw media data for transmission to a sender comprises formation of one or more primary and redundant packets, wherein the primary and redundant packets include the raw media data.

Example 20 can include one or more examples, wherein the formation of one or more packets with raw media data for transmission to a sender comprises include metadata in the one or more packets, wherein the metadata comprises one or more of: timestamp, histogram of video line positions of the raw media data, source Internet Protocol (IP) address, destination IP address, source User Datagram Protocol (UDP) port, or destination UDP port.

Example 21 can include one or more examples and a non-transitory computer-readable medium comprising instructions stored thereon, that if executed by one or more processors, cause the one or more processors to: configure a packet processing device to indicate to a processor-executed operating system (OS) capability to form one or more packets with raw media data for transmission to a sender based on a Real-time Transport Protocol (RTP).

Example 22 can include one or more examples, wherein the form one or more packets with raw media data for transmission to a sender based on a RTP is consistent with Society of Motion Picture and Television Engineers (SMPTE) 2110 (2018).

What is claimed is:

1. An apparatus comprising:
a packet processing device comprising:
circuitry to form one or more packets with raw media data for transmission to a sender based on a Real-time Transport Protocol (RTP).

2. The apparatus of claim 1, wherein the circuitry is to form one or more packets with raw pixel media in a manner consistent with Society of Motion Picture and Television Engineers (SMPTE) 2110 (2018).

3. The apparatus of claim 1, wherein the raw media data comprises one or more of: raw video and/or raw audio data.

4. The apparatus of claim 1, wherein to form one or more packets with raw media data for transmission to a sender, the circuitry is to form one or more primary and redundant packets, wherein the primary and redundant packets include the raw media data.

5. The apparatus of claim 1, wherein to form one or more packets with raw media data for transmission to a sender, the circuitry is to include metadata in the one or more packets, wherein the metadata comprises one or more of: timestamp, histogram of video line positions of the raw media data, source Internet Protocol (IP) address, destination IP address, source User Datagram Protocol (UDP) port, or destination UDP port.

6. The apparatus of claim 5, wherein packets belonging to a same video frame share a same timestamp.

7. The apparatus of claim 1, wherein to form one or more packets with raw media data for transmission to a sender, the circuitry is to manage multi-protocol label switching (MPLS), virtual local area network (VLAN), or Virtual Extensible LAN (VxLAN).

8. The apparatus of claim 1, comprising a host system communicatively coupled to the packet processing device, wherein the host system is to generate the raw media data.

9. The apparatus of claim 1, wherein the packet processing device comprises one or more of: a network interface controller (NIC), a remote direct memory access (RDMA)-enabled NIC, SmartNIC, router, switch, forwarding element, infrastructure processing unit (IPU), or data processing unit (DPU).

10. An apparatus comprising:
a packet processing device comprising:
circuitry to access one or more received packets received via a Real-time Transport Protocol (RTP) and reconstruct frames of raw media data from content of the one or more received packets.

11. The apparatus of claim 10, wherein the packet processing device comprises circuitry to terminate network communications can terminate IP Security (IPSEC), multi-protocol label switching (MPLS), or Virtual Extensible LAN (VxLAN) of received primary and redundant packets.

12. The apparatus of claim 10, wherein the packet processing device comprises circuitry to identify and bifurcate received primary and redundant packets and select one or more received video frames from the primary and redundant packets.

13. The apparatus of claim 10, wherein the packet processing device comprises circuitry to copy a video frame of the raw media data to a frame buffer in a host system.

14. The apparatus of claim 10, wherein the one or more received packets are consistent with Society of Motion Picture and Television Engineers (SMPTE) 2110 (2018).

15. The apparatus of claim 10, wherein the raw media data comprises one or more of: raw video and/or raw audio data.

16. A non-transitory computer-readable medium comprising instructions stored thereon, that if executed by one or more processors, cause the one or more processors to:
offload to a packet processing device: formation one or more packets with raw media data for transmission to a sender based on a Real-time Transport Protocol (RTP).

17. The computer-readable medium of claim 16, wherein the packet processing device is to form one or more packets with raw pixel media in a manner consistent with Society of Motion Picture and Television Engineers (SMPTE) 2110 (2018).

18. The computer-readable medium of claim 16, wherein the raw media data comprises one or more of: raw video and/or raw audio data.

19. The computer-readable medium of claim 16, wherein the formation of one or more packets with raw media data for transmission to a sender comprises formation of one or more primary and redundant packets, wherein the primary and redundant packets include the raw media data.

20. The computer-readable medium of claim 16, wherein the formation of one or more packets with raw media data for transmission to a sender comprises include metadata in the one or more packets, wherein the metadata comprises one or more of: timestamp, histogram of video line positions of the raw media data, source Internet Protocol (IP) address, destination IP address, source User Datagram Protocol (UDP) port, or destination UDP port.

21. A non-transitory computer-readable medium comprising instructions stored thereon, that if executed by one or more processors, cause the one or more processors to:
configure a packet processing device to indicate to a processor-executed operating system (OS) capability to form one or more packets with raw media data for transmission to a sender based on a Real-time Transport Protocol (RTP).

22. The computer-readable medium of claim 21, wherein the form one or more packets with raw media data for transmission to a sender based on a RTP is consistent with Society of Motion Picture and Television Engineers (SMPTE) 2110 (2018).
